(19) United States
(12) Patent Application Publication
(10) Pub. No.: US 2025/0200541 A1
(43) Pub. Date: Jun. 19, 2025

(54) KNOWLEDGE GRAPH-BASED INFRASTRUCTURE PAYMENT SERVICES

(71) Applicant: Dell Products L.P., Round Rock, TX (US)

(72) Inventors: Stephen J. Todd, North Andover, MA (US); Ahmed Khalid, Cork (IE); Sarah Evans, Parker, CO (US)

(21) Appl. No.: 18/544,241

(22) Filed: Dec. 18, 2023

(51) Int. Cl. G06Q 20/14; G06Q 20/40

(52) U.S. Cl. CPC G06Q 20/14; G06Q 20/4014

(57) ABSTRACT

One example method includes, for a component of a hardware device, registering a component ID and billing information, creating a data structure that comprises an aggregator node that corresponds to an aggregator, and a node that corresponds to the component, receiving, from a vendor of the component, an acknowledgement as to the accuracy and completeness of the data structure insofar as information in the data structure applies to the component, collecting telemetry concerning operation of the component, and using the telemetry as a basis for performing a process concerning the component and/or operation of the component.

### FIELD OF THE INVENTION

Embodiments of the present invention generally relate to resource consumption in edge environments. More particularly, at least some embodiments of the invention relate to systems, hardware, software, computer-readable media, and methods, for tracking resource consumption, possibly on a component level basis, in edge environments.

### BACKGROUND

Some consumers increasingly desire an OPEX (operational expenditures)-style payment model, allowing them to avoid up-front capital expenditures in IT (information technology) equipment in favor of pay-as-you-go usage of IT services and HW (hardware). While cloud-based consumption models may be employed for that purpose, edge-based deployments face more of a challenge, as exemplified by the hypothetical configuration shown in FIG. 1.

Particularly, FIG. 1 highlights the complexity and enormous number of heterogeneous vendors, products, and services that must come together to provide IT services in an edge environment. For example, there may be hundreds of thousands of Internet of Things (IoT) devices connected to networks and generating data to support business functions.

For example, in an environment such as that disclosed in FIG. 1, there may be dozens or hundreds of private and public networks that route sensor data to processing units and storage systems, all needing provisioning and monitoring to do so securely.

As another example, there may be hundreds or thousands of processing units that perform data management operations. Such processing units may include, for example, gateways, and edge servers. Further, such data management operations may include, but are not limited to, analysis, cleaning, encrypting, compressing, and storing.

As well, there may be dozens, or hundreds, or more, of storage systems that persist a subset of the data. There may be dozens or hundreds of applications/services that perform system-wide or local tasks. And, there are security services that perform tasks related to privacy, authentication and authorization, encryption, and compliance, for example.

Integrating all of these hardware and software vendors together in a secure, predictable, and performant matter is challenging. Moreover, customers that are deploying these edge ecosystems are extremely hesitant to pay every vendor up-front for the solution. The customers would much prefer to negotiate up-front contracts that specify “by-the-drip” payments (operational expenditures or OPEX) based on system operation of individual components.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example edge IT ecosystem in which an embodiment of the invention may be implemented.

FIG. 2 discloses aspects of the use of DLT (distributed ledger technology) in a manufacturing and onboarding flow, according to an embodiment.

FIG. 3 discloses aspects of an example knowledge graph of payment terms for a server and its components, according to an embodiment.

FIG. 4 discloses aspects of a payment proxy service knowledge graph, according to an embodiment.

FIG. 5 discloses aspects of a knowledge graph association with a component such as a manufactured server, according to an embodiment.

FIG. 6 discloses aspects of a method according to one embodiment.

FIG. 7 discloses aspects of a computing entity configured to perform any of the disclosed methods, processes, and operations.

### DETAILED DESCRIPTION OF SOME EXAMPLE EMBODIMENTS

Embodiments of the present invention generally relate to resource consumption in edge environments. More particularly, at least some embodiments of the invention relate to systems, hardware, software, computer-readable media, and methods, for tracking resource consumption, possibly on a component level basis, in edge environments. An example of an edge environment is an IT infrastructure that resides outside of a data center and, as such, may be located relatively closer to where operational data is created and/or lives. Accordingly, in an embodiment, an edge environment may process data that is generated in the edge environment and/or elsewhere. An edge environment may comprise a distributed computing framework that may comprise various edge devices, examples of which are disclosed herein.

In one example embodiment, a device, such as a server for example, may be manufactured that includes various different components, each of which may have been manufactured by a different respective vendor. The operation of the device may be controlled by an aggregator entity, and the device may record its installation and state, such as in a distributed ledger, when it is up and running at a business location or other site.

The aggregator may create, and use, a knowledge graph that includes information concerning usage of the various components. In an embodiment, this information in the knowledge graph may include contractual information, such as payment terms, that specifies a cost, per usage for example, for a customer to use each of the components that makes up the device. In one embodiment, the respective payment terms for each vendor may be combined in an immutable, digitally signed, agreement that is created after the device is manufactured.

After the knowledge graph has been built, the aggregator may then parse the knowledge graph to ensure that all of the various payment terms, and/or other information, are correct and consistent with each other. When the knowledge graph has thus been validated, then it may be versioned and acknowledged, such as with a digital signature, by each of the vendors, and the digital signatures may be added to the knowledge graph.

With the knowledge graph in place and acknowledged, respective telemetry may be gathered, such as by the aggregator for example, concerning the components of the device. This telemetry may comprise, for example, customer usage information for the various components, such as how much disk space, memory, CPU, and/or bandwidth were used in a given time period. In an embodiment, the telemetry information may be used for billing purposes, and/or to track component lifecycles.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that customer usage of individual components of a device may be tracked as that usage occurs. In an embodiment, component usage information may be used as a basis for various additional processes, such as billing a customer for usage of that component. Various other advantages of one or more example embodiments will be apparent from this disclosure.

### A. Aspects of an Example Operating Environment

The following is a discussion of aspects of example operating environments for various embodiments of the invention. This discussion is not intended to limit the scope of the invention, or the applicability of the embodiments, in any way.

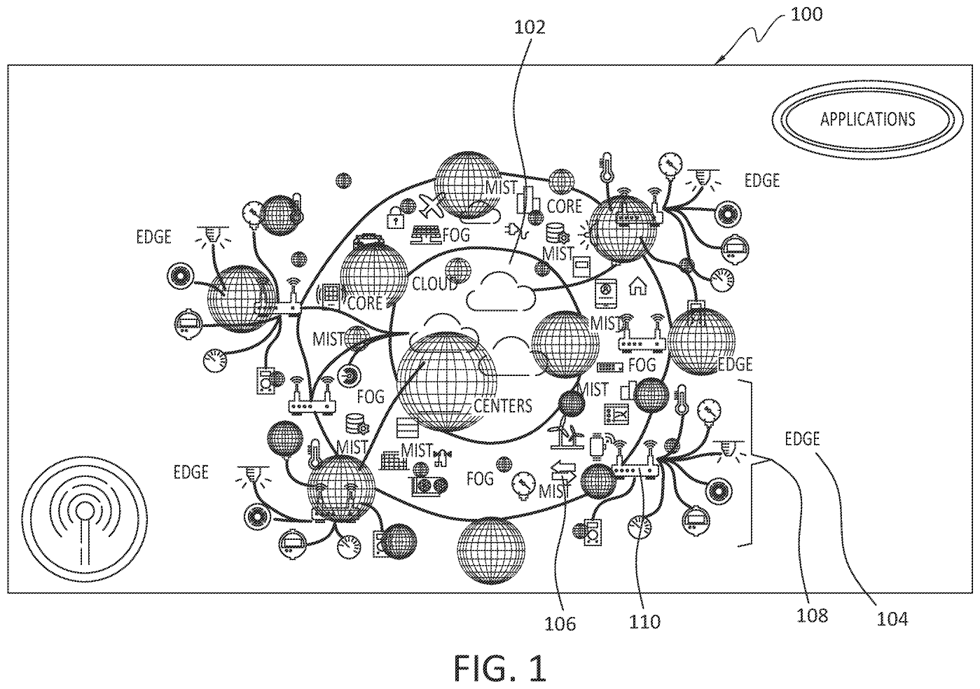

Referring again to FIG. 1, there is disclosed an example operating environment 100 that may comprise a cloud site 102, which may comprise cloud storage and/or cloud computing functionality, and one or more edge sites 104 that are able to communicate with the cloud site 102 for the exchange of data 106 and/or other information. An edge site 104 may comprise a mobile device, such as a mobile phone for example, and another edge site 104 may comprise an IoT device. The edge sites 104, with or without the cloud site 102, may define a network. Additionally, or alternatively, one or more of the edge sites 104 may comprise various types of sensors 108, and/or more one or more autonomous devices such as a drone or vehicle for example. Such sensors may comprise, for example, pressure sensors, smoke detectors, thermometers, sound detection devices such as microphones, clocks, and any other device(s) operable to collect information concerning physical aspects of a physical environment. In an embodiment, information collected by the sensors 108 may be transmitted to a server 110, and/or other components, for collection and processing. The server 110 may, in an embodiment, comprise an element of a cloud site, such as the cloud site 102. Any of the elements of the operating environment 100 may comprise one or more applications, memory, storage, and one or more processors, as well as components for transmitting and receiving data. The example operating environment 100 is presented for the purposes of illustration and is not intended to limit the scope of the invention in any way.

### B. Aspects of One or More Example Embodiments

As noted earlier, customers who need access to functionality provided, for example, by a system or device such as a server are often unwilling to take a CAPEX (capital expenditure) approach to obtaining that functionality. That is, the customers would prefer not to make a capital expenditure to obtain an asset such as a server and, instead, would prefer to simply pay for the functionality on an as-used basis, which is sometimes referred to as a ‘by-the-drip’ payment scheme. While such a scheme may be preferred by the customer, it can be relatively challenging for the owner of the asset to implement. Note that, as used herein, the entity that controls customer access to the functionality provided by an asset may be referred to as an ‘aggregator’ insofar as the asset may aggregate a variety of different functions, implemented by respective components of the asset or device, to which one or more customers may need access. Thus, an example embodiment may comprise various features and aspects to meet challenges such as those noted above.

In order to describe the difficulty of pay-as-you-go for edge services, consider the aggregation example of a manufactured server containing various components, such as a CPU (central processing unit), memory, network card, disk, running a specific edge operating system.

To meet such challenges, an embodiment may implement various functionalities. One such functionality concerns aggregator billing. In particular, an aggregator of a set of vendor components, such as a server manufacturer for example, would ordinarily pay up front for all the components that they aggregate together in the finished product. However, if an edge ecosystem customer does not want to pay up front for a server but prefers to pay for the utilization of the server, this puts the server manufacturer in a bind, because the server manufacturer is paying component vendors up front for the component hardware, such as CPU and memory for example, and software, such as the OS (operating system) or services running on that OS. Accordingly, an embodiment may provide a mechanism that may enable the aggregator, and/or another entity, to effectively and accurately bill the customer for the server functionalities employed by the consumer.

Another functionality that may be implemented by an embodiment concerns the lack of “electronic” pay-as-you-go terms and as-you-go payment for components on the edge. In particular, component vendors, such as CPU manufacturers for example, have no way to specify “usage charges” such as, for example, 5 cents per hour for 50% or more utilization, for components that get aggregated into products and shipped into edge environments. Moreover, there is no way to audit usage information across edge environments to know what those component vendors should have been paid for based on the customer usage of the vendor components. For example, if telemetry is gathered for a specific component, there is presently no way to “instantly” pay the vendor based on the telemetry data for that component. Accordingly, an embodiment may provide a mechanism that may enable the aggregator, and/or another entity, to effectively and accurately bill the customer for the various component functionalities utilized by the consumer.

As another example, an embodiment may comprise a mechanism for specifying to the aggregation vendor how often, and when, the vendor should receive payment for the usage of their component(s). This feature of an embodiment may address the fact that there is presently no way for a component vendor to specify dynamic/batch component payment mechanisms.

Further, an embodiment may comprise a mechanism for validating/tracking payment terms across aggregators and components. This feature may be useful in circumstances where, if an aggregator, such as a server vendor, wishes to charge $X/hr. for server usage, it would be difficult for the server vendor to balance its own payment terms with the multiple underlying payment terms of the hardware and software components running on the system.

As a final example of features and aspects of an embodiment, one embodiment may comprise a mechanism for assessing the impact on payment terms of updating firmware/software of a component of a vendor system/device. This mechanism may be useful should a component at an edge node be updated with newer firmware or software features. This mechanism may thus help to avoid a situation where such updates would otherwise cause a disruption to the original terms with the server vendor.

It is noted that while various examples of aspects of one or more embodiments disclosed refer to servers, the same considerations apply equally to the hundreds or thousands of other types of hardware, such as storage, routers and other network devices, and the software running thereon, that may be present in the larger edge ecosystem. Thus, the references herein to a server, and its components, are only for the purposes of illustration and are not intended to limit the scope of the invention in any way.

### C. Detailed Discussion of Aspects of an Example Embodiment

Distributed ledger technology (DLT) may play an important role in many edge functions, including, for example:
onboarding edge hardware devices in a secure way such as, for example, secure device onboarding, where a new device “registers” upon first installation and boot;
tracking data management operations, such as trust insertion operations involving secure enclaves, and calculating a score for data, as in the case, for example of ‘Project Alvarium’/DCF (data confidence fabric); and
tracking the state of edge hardware and enabling trustworthy configuration upgrades.

The use, in DLT, of peer-to-peer consensus, digital signatures, and cryptography, may enable the DLT, which may comprise an immutable shared ledger, to function as a “source of truth” that can usually be found “nearby” to enable distributed/decentralized edge ecosystems to function in a more trustworthy way. Further, distributed ledger technology also holds the promise of decentralized payment mechanisms, as many ledger protocols contain wallet transfer services to move currency from one wallet to another. As discussed below, DLT may be implemented as an element of one or more embodiments.

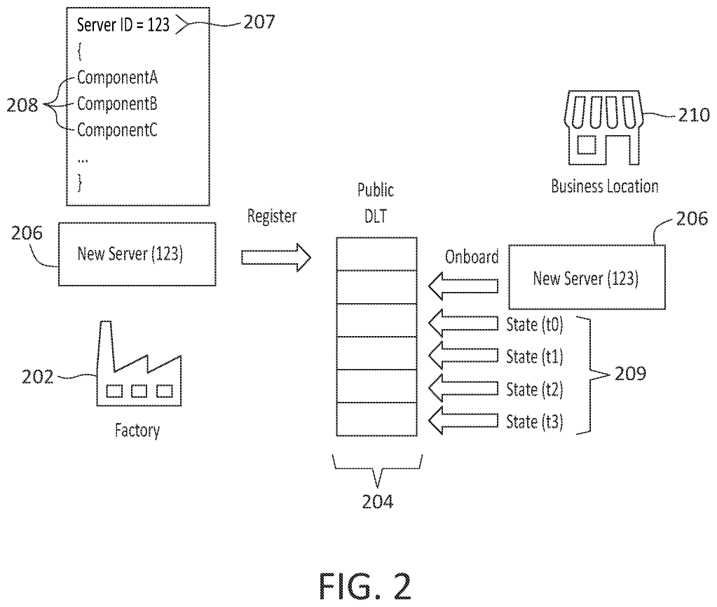

In particular, and with reference now to FIG. 2, a factory 202 may use a public DLT 204 to store, or register, information about a recently manufactured server 206 that may be identified with a device-specific ID 207 and comprise one or more components 208, each of which may be supplied by a different respective vendor. This information may include, but is not limited to, the device-specific ID 207, the manufacturer of the server 206, the components 208, and the respective manufacturers of the components 208. As well, the server 206 may record, in the public DLT 204, its installation and one or more subsequent state(s) 209 once it is up and running at a business location 210.

In an embodiment, the approach disclosed in FIG. 2, namely, storing manufacturing information in a ledger, such as the public DLT 204, and then updating that ledger during and after installation of a device, such as the server 206 for example, may be augmented with a knowledge graph approach. Examples of some knowledge graphs that may be employed in one or more embodiments are discussed below.

### C.1 Modeling Vendor Billing Using a Knowledge Graph

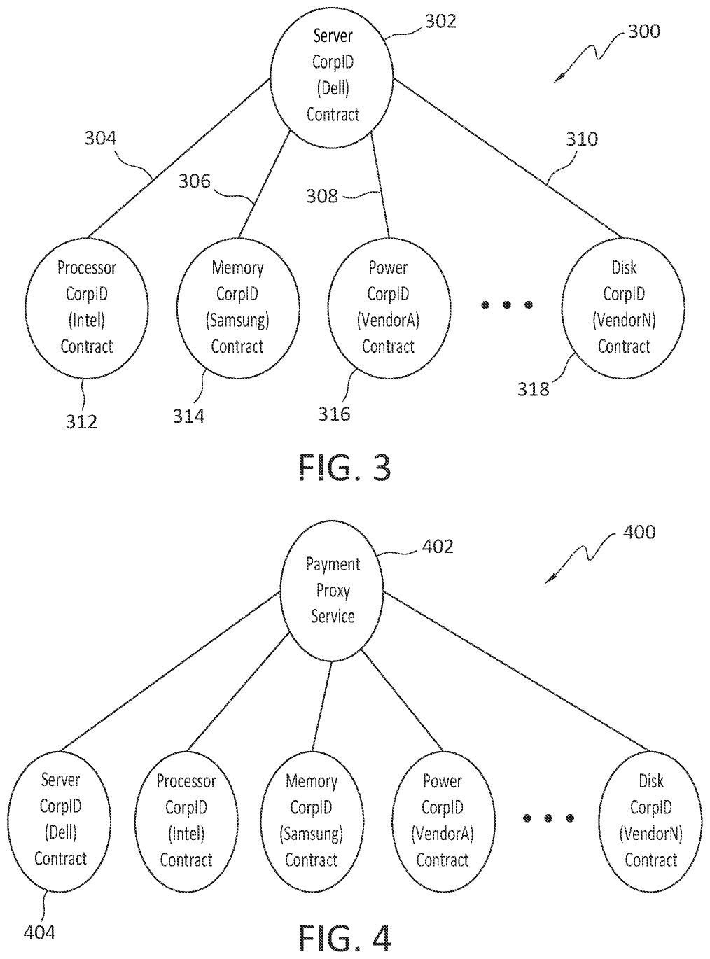

FIG. 3 discloses a data structure 300 in the form of a knowledge graph. In other embodiments, the data structure 300 may comprise a tree, or a DAG (Directed Acyclic Graph), for example. The data structure 300 comprises information about contractual terms, such as billing terms for example, that apply to the usage of any given component, such as of a server for example, in the graph. The data structure 300 may also comprise information about terms that facilitate payment to the respective entities associated with the components.

In more detail, a top node 302 corresponds to a component, such as a server for example, provided by an aggregator, such as Dell, a Corporate ID identifying the aggregator as Dell in this example, and contractual terms for the use of the server. Such contractual terms may comprise pay-as-you-go contractual terms that may be based on an extent to which each component of the server is used by one or more customers.

The data structure 300 may also comprise connections 304, 306, 308, and 310, from the top node 302 to respective nodes 312, 314, 316, and 318, that correspond to server components, which may have been assembled together and tested by the aggregator. Each of these sub-components in the data structure 300 may also comprise identity information and contractual terms describing expected payment for usage of their products. Thus, for example, the node 312 contains information pertaining to a processor component of the server, namely, a corporate ID that identifies Intel as the manufacturer of the processor component, and contractual terms for the use of the processor. Note that additional subcomponent layering is possible. For example, an SSD may have sub-components from different vendors, such as a controller, flash memory, and DRAM. More generally, there is no limit to the information, number of nodes, layers, and components, that may be included in a data structure, such as the data structure 300.

It is noted that the corporate ID may be implemented in a wide variety of ways. For example, the corporate ID may be a corporate wallet address, a text string or other identifier, or a decentralized identity (DID). Further, the contractual terms may refer to various mechanisms for implementing the contract, including a reference to a smart contract, a reference to a traditional, or legacy, contractual agreement, or some other codified mechanism that indicates billing and payment terms.

With reference next to FIG. 4, a data structure 400, such as a knowledge graph for example, is disclosed. The data structure 400 may be similar, or identical, to the data structure 300 except that the top node 402 of the data structure 400 corresponds to a payment proxy service, and an aggregator node 404 is in the first layer of the data structure 400. In the example of FIG. 4, the 3rd party proxy payment vendor, to which the top node 402 corresponds, provides a service for handling payment distribution both to the aggregator, and to the various vendors respectively associated with the device components. In the example of FIG. 3, by contrast, the aggregator may handle the payment distributions.

In either case, that is, of the data structure 300 or the data structure 400, the data structure represents and/or comprises an agreed-upon set of rules for how every vendor expects to be paid when their technology, which may comprise hardware and/or software, is used after deployment of the device that includes the various components. The following discussion is concerned with one or more example mechanisms to facilitate, and/or implement, payments.

### C.2 Knowledge Graph Validation

The use of a knowledge graph may enable a top-level payment handler, such as a proxy payment service or aggregator for example, to parse the entire graph to determine whether or not the aggregation of all of the contractual terms is accurate, and whether those terms are consistent with each other, and applicable constraints have been satisfied. For example, if Dell were the top-level aggregator, Dell could parse the contractual terms of all the sub-component vendors to validate that, after these vendors get paid, there is enough of a balance to pay itself. If not, Dell can use this data to re-evaluate the contract terms, such as on a rolling basis for example.

### C.3 Acknowledgement and Immutable Record of Knowledge Graph

Once the knowledge graph terms have been validated, such as by an aggregator, the knowledge graph may be “versioned” and “acknowledged” by all vendors that are represented in the knowledge graph. This versioning and acknowledgment may be performed in various ways. For example, each node in the graph may be digitally signed by each vendor represented by the graph, and these signatures may become part of the knowledge graph. Alternatively, the knowledge graph may be stored, such as in an immutable object store or an immutable distributed ledger, and a hash of the knowledge graph generated. This hash may be digitally signed by all vendors as well.

C.4 Association of Knowledge Graph Immutable ID with Manufactured Server

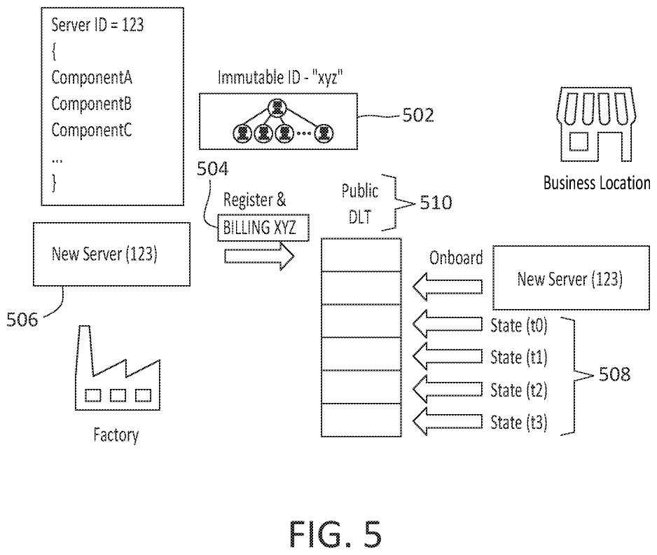

With reference now to FIG. 5, there is disclosed a variation of the manufacturing process disclosed in FIG. 2, in which knowledge graph billing terms are registered at the same time as the manufacturing data. In an embodiment, these terms may be unique to any given server, or they may apply to every server, or a batch of servers.

FIG. 5 discloses an immutable, digitally signed agreement 502, across multiple component vendors, to distribute payment based on agreed-upon terms 504. The agreement 502 and the terms 504 may be associated with a device, such as a server 506, at the time the server is manufactured.

While reference is made here to the use of knowledge graphs, and associated telemetry, to enable billing processes, and to accumulate data concerning component usage, the scope of the invention is not limited to these example applications. For example, knowledge graphs, and associated telemetry, have other use cases in holistic activities, such as security. In particular, identity information, such as the immutable device IDs and/or data provenance, and other telemetry may be helpful to implement and maintain supply chain security and could be shared as needed with security systems and personnel as/if needed.

### C.5 Leveraging Knowledge Graph Terms to Facilitate Payment Based on State

After the knowledge graph, or other data structure, has been completed, respective telemetry from the various components that make up the aggregate device may be collected. In an embodiment, the telemetry 508 associated with various different states of the device/components may be collected. For example, the telemetry coming back from the state information at times t(0), t(1), . . . t(n) may be collected and evaluated. In an embodiment, the state information may comprise telemetry that contains usage information such as, for example, how much memory, CPU, and/or disk, was used during a given time period.

The recording of the state information 508 in a ledger 510 may result in payment to the various vendors, according to the terms in the knowledge graph. This payment may be implemented in any number of ways, including batch processing of the ledger 510 after the fact, that is, after all of the applicable state information 508 is recorded in the ledger 510. In an embodiment, payment may be made using granular smart contract calls to make payments immediately upon processing the telemetry, that is, immediately after the state information 508 for a component is recorded in the ledger 510. In an embodiment, granular, instant payments may be implemented, for example, by performing a cryptocurrency transfer from a well-known user wallet to the “identity,” such as a wallet address, to the component(s) vendor(s) indicated by the telemetry, by using the identity, such as a destination wallet address, to which the payment is sent.

### D. Example Methods

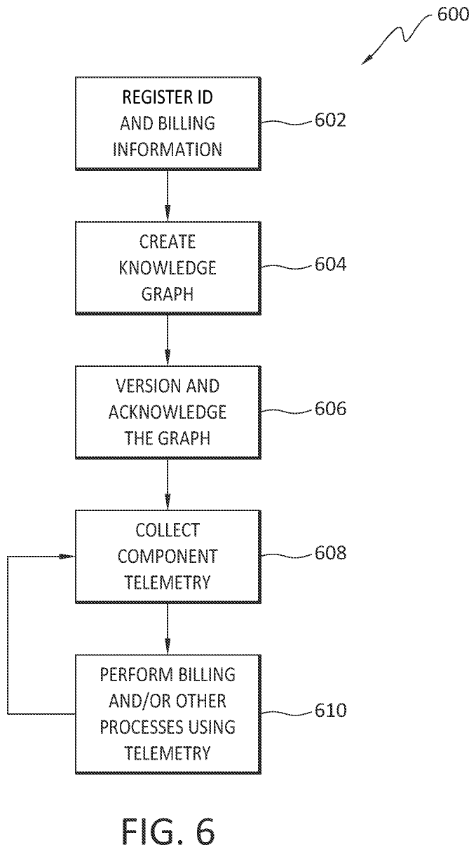

It is noted with respect to the disclosed methods, including the example method of FIG. 6′, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 6, a method 600 according to one embodiment is disclosed. The method 600 may begin with the registration 602 of an ID and billing information for one or more components of a device. The ID and billing information may be registered 602 before, during, or after, the device in which the various components are aggregated has been manufactured. In an embodiment, the ID and billing information may be registered 602 in a public, immutable, register, one example of which is a blockchain. No particular type of immutable register is required to be employed however.

A knowledge graph, or other data structure, may then be constructed 604 that identifies an aggregator, and each component in, or selected components of, a device associated with the aggregator. The knowledge graph may include information about each of the components, and about the aggregator, as well as information about relationships between the components and the device. The information about the components may comprise, for example, a component ID, a component type, identity of a vendor/manufacturer of the component, and the billing information relating to that component.

After the knowledge graph is constructed 604, the aggregator may validate the knowledge graph and request that each vendor acknowledge 606 the knowledge graph, that is, each vendor may confirm that the information and terms of the knowledge graph that are applicable to it are correct and complete. In an embodiment, the aggregator or another entity may enable the vendors to access the knowledge graph, which may be stored by/at the aggregator and/or a third party payment proxy, and then query the vendors for acknowledgement.

After the vendors have acknowledged 606 the knowledge graph, telemetry may be collected 608 from the selected component(s) of the device that includes those components. In an embodiment, the telemetry, which may comprise information indicating an extent to which various components of the device have been used by various customers, may be collected and stored by the aggregator.

The telemetry information may then be used 610 to support various processes. For example, the telemetry information may be used as a basis for generating an invoice for a customer, where the invoice may indicate, for example, amount(s) billed to the customer for usage of the applicable component(s) of the device. In this example, payment received from the customer, such as by an aggregator or payment proxy service for example, may then be passed to the respective vendor(s) of those component(s).

Finally, as shown in FIG. 6, the telemetry collection 608 and billing/other processes may be performed on an ongoing basis. If a component is removed from service for any reason, telemetry collection for that component may be terminated.

### E. Further Example Embodiments

Following are some further example embodiments of the invention. These are presented only by way of example and are not intended to limit the scope of the invention in any way.

Embodiment 1. A method, comprising: for a component of a hardware device, registering a component ID and billing information; creating a data structure that comprises an aggregator node that corresponds to an aggregator, and a node that corresponds to the component; receiving, from a vendor of the component, an acknowledgement as to an accuracy and completeness of the data structure insofar as information in the data structure applies to the component; collecting telemetry concerning operation of the component; and using the telemetry as a basis for performing a process concerning the component and/or operation of the component.

Embodiment 2. The method as recited in any preceding embodiment, wherein the node corresponding to the component includes information that comprises the component ID, the billing information, and an identity of a vendor of the component.

Embodiment 3. The method as recited in any preceding embodiment, wherein the component ID and billing information are registered in an immutable ledger.

Embodiment 4. The method as recited in any preceding embodiment, wherein the aggregator node is associated with an entity that manufactured the device, and the aggregator node includes a vendor ID, billing information concerning the hardware device and/or the component, and a device ID.

Embodiment 5. The method as recited in any preceding embodiment, wherein the billing information indicates an amount to be paid, to a vendor of the component, for customer usage of the component.

Embodiment 6. The method as recited in any preceding embodiment, wherein the telemetry comprises information indicating an extent to which the component was used by one or more customers.

Embodiment 7. The method as recited in any preceding embodiment, wherein the process comprises billing a customer for usage of the component.

Embodiment 8. The method as recited in any preceding embodiment, wherein the telemetry is derived from state information, for the component, that is stored in an immutable ledger that includes state information for one or more other components, and a batch processing of the state information in the immutable ledger is performed, and payment to respective vendors of the component and the one or more other components is made based on the batch processing.

Embodiment 9. The method as recited in any preceding embodiment, wherein the data structure is stored in an immutable ledger that also includes the component ID and the billing information.

Embodiment 10. The method as recited in any preceding embodiment, wherein the data structure further comprises a payment proxy service node that communicates with the aggregator node, and the payment proxy service is operable to implement distribution of a customer payment, for use of the component, to the vendor and to the aggregator.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

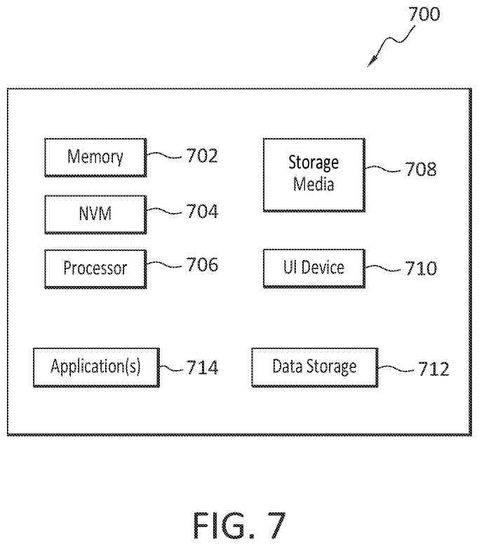

With reference briefly now to FIG. 7, any one or more of the entities disclosed, or implied, by FIGS. 1-6, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
for a component of a hardware device, registering a component ID and billing information;
creating a data structure that comprises an aggregator node that corresponds to an aggregator, and a node that corresponds to the component;
receiving, from a vendor of the component, an acknowledgement as to an accuracy and completeness of the data structure insofar as information in the data structure applies to the component;
collecting telemetry concerning operation of the component; and
using the telemetry as a basis for performing a process concerning the component and/or operation of the component.

2. The method as recited in claim 1, wherein the node corresponding to the component includes information that comprises the component ID, the billing information, and an identity of a vendor of the component.

3. The method as recited in claim 1, wherein the component ID and billing information are registered in an immutable ledger.

4. The method as recited in claim 1, wherein the aggregator node is associated with an entity that manufactured the device, and the aggregator node includes a vendor ID, billing information concerning the hardware device and/or the component, and a device ID.

5. The method as recited in claim 1, wherein the billing information indicates an amount to be paid, to a vendor of the component, for customer usage of the component.

6. The method as recited in claim 1, wherein the telemetry comprises information indicating an extent to which the component was used by one or more customers.

7. The method as recited in claim 1, wherein the process comprises billing a customer for usage of the component.

8. The method as recited in claim 1, wherein the telemetry is derived from state information, for the component, that is stored in an immutable ledger that includes state information for one or more other components, and a batch processing of the state information in the immutable ledger is performed, and payment to respective vendors of the component and the one or more other components is made based on the batch processing.

9. The method as recited in claim 1, wherein the data structure is stored in an immutable ledger that also includes the component ID and the billing information.

10. The method as recited in claim 1, wherein the data structure further comprises a payment proxy service node that communicates with the aggregator node, and the payment proxy service is operable to implement distribution of a customer payment, for use of the component, to the vendor and to the aggregator.

11. A non-transitory storage medium having stored therein instructions that are executable by one or more hardware processors to perform operations comprising:
for a component of a hardware device, registering a component ID and billing information;
creating a data structure that comprises an aggregator node that corresponds to an aggregator, and a node that corresponds to the component;
receiving, from a vendor of the component, an acknowledgement as to an accuracy and completeness of the data structure insofar as information in the data structure applies to the component;
collecting telemetry concerning operation of the component; and
using the telemetry as a basis for performing a process concerning the component and/or operation of the component.

12. The non-transitory storage medium as recited in claim 11, wherein the node corresponding to the component includes information that comprises the component ID, the billing information, and an identity of a vendor of the component.

13. The non-transitory storage medium as recited in claim 11, wherein the component ID and billing information are registered in an immutable ledger.

14. The non-transitory storage medium as recited in claim 11, wherein the aggregator node is associated with an entity that manufactured the device, and the aggregator node includes a vendor ID, billing information concerning the hardware device and/or the component, and a device ID.

15. The non-transitory storage medium as recited in claim 11, wherein the billing information indicates an amount to be paid, to a vendor of the component, for customer usage of the component.

16. The non-transitory storage medium as recited in claim 11, wherein the telemetry comprises information indicating an extent to which the component was used by one or more customers.

17. The non-transitory storage medium as recited in claim 11, wherein the process comprises billing a customer for usage of the component.

18. The non-transitory storage medium as recited in claim 11, wherein the telemetry is derived from state information, for the component, that is stored in an immutable ledger that includes state information for one or more other components, and a batch processing of the state information in the immutable ledger is performed, and payment to respective vendors of the component and the one or more other components is made based on the batch processing.

19. The non-transitory storage medium as recited in claim 11, wherein the data structure is stored in an immutable ledger that also includes the component ID and the billing information.

20. The non-transitory storage medium as recited in claim 11, wherein the data structure further comprises a payment proxy service node that communicates with the aggregator node, and the payment proxy service is operable to implement distribution of a customer payment, for use of the component, to the vendor and to the aggregator.
